(19) United States
(12) Patent Application Publication
(10) Pub. No.: US 2015/0294404 A1
(43) Pub. Date: Oct. 15, 2015

(54) METHOD AND SYSTEM FOR LEGAL PROCESSING FOR DEBT COLLECTION

(71) Applicants: Matthew C. Wolk, Cedar Falls, IA (US); Michael L. Frost, Cedar Falls, IA (US)

(72) Inventors: Matthew C. Wolk, Cedar Falls, IA (US); Michael L. Frost, Cedar Falls, IA (US)

(73) Assignee: Innovation Software, LLC, Cedar Falls, IA (US)

(21) Appl. No.: 14/250,541

(22) Filed: Apr. 11, 2014

(51) Int. Cl. G06Q 40/00; G06Q 50/18; G06Q 10/06

(52) U.S. Cl. CPC G06Q 40/00; G06Q 10/063114; G06Q 10/0633; G06Q 50/18

(57) ABSTRACT

A method includes providing a customer relationship management (CRM) system executing on one or more servers, providing a vendor interface to the CRM system, providing a client interface to the CRM system, wherein the client interface enables clients to send accounts to the CRM system for pre-legal and legal work, monitor performance on the accounts, and review the accounts, providing an attorney interface to the CRM system, wherein the attorney interface provides for receiving the accounts in the legal work flow and reporting on status of the accounts in the legal work flow, and providing a consumer interface to the CRM system, wherein the consumer interface enables a consumer to view and make payments to an account associated with the consumer. Whereas, all parts are managed by one entity instead of several across various platforms and structures.

### FIELD OF THE INVENTION

The present invention relates to debt collection. More particularly, but not exclusively, the present invention relates to methods and systems for performing legal processing associated with debt collection.

### BACKGROUND OF THE INVENTION

Debt collection has numerous complexities and problems. These complexities may make it difficult for all parties involved in the process including consumers who have incurred the debt, creditors who are owed the debt, agencies who work on behalf of the creditors to collect the debt, and lawyers involved in the debt recovery process. What are needed are better ways to deal with consumer debt collection as it relates to legal collections

### SUMMARY OF THE INVENTION

Therefore it is primary object, feature, or advantage to the present invention to improve over the current state of the art.

It is a further object, feature, or advantage of the present invention to create client and consumer transparency into and throughout the process of legal recoveries.

It is another object, feature, or advantage of the present invention to provide a single point of interaction for consumers during the life of the legal process.

It is another object, feature, or advantage of the present invention to provide a single source system for 100% of the phone calls and processing related to the legal process for debt collection.

Another object, feature, or advantage of the present invention is to provide completely transparent functionality for all legal accounts.

Yet another object, feature, or advantage of the present invention is to establish increased levels of control over each step in the process.

Yet another object, feature, or advantage of the present invention is to increase expense validation.

Yet another object, feature, or advantage of the present invention is to provide a system with coded rules required for each next step in the process.

A still further object, feature, or advantage of the present invention is to provide the ability to stop accounts anywhere within the legal recovery process.

Yet another object, feature, or advantage of the present invention is to eliminate the system of record conflicts and restraints.

A further object, feature, or advantage of the present invention is to provide a single source for balance calculations, payment, and cost posting.

Another object, feature, or advantage of the present invention is to provide adaptability to client payment posting (including interest calculations).

A still further object, feature, or advantage of the present invention is to provide a single point of record for validation of accounts, confirmation of balances, document sources and other information.

Yet another object, feature, or advantage of the present invention is to provide the opportunity for the clients to gain control over risk

A still further object, feature, or advantage of the present invention is to provide a client with the ability to directly see, hear, and touch all accounts in any step within the process.

Yet another object, feature, or advantage of the present invention is to provide for management of state and court level requirements and changes.

Yet another object, feature, or advantage of the present invention is to establish applicable “scrubs” at each move to invalidate suit process steps.

A further object, feature, or advantage of the present invention is to allow for consumer interaction points for account viewing.

Yet another object, feature, or advantage of the present invention is to provide a method by which network attorneys are returned to focus primarily on their training.

Another object, feature, or advantage of the present invention is to eliminate system of record (SOR) variances.

A further object, feature, or advantage of the present invention is to allow a debt collection entity to control the entire process so that their regulatory strengths to manage and control the process, and their call center management skills to remove variability may be leveraged.

One or more of these and/or other objects, features, or advantages of the present invention will become apparent from the specification and claims that follow. No single embodiment need to exhibit each and every object, feature, or advantage of the present invention. It is contemplated that different embodiments may have different objects, features, or advantages.

According to one aspect, a method for managing legal recoveries is provided. The method includes providing a customer relationship management (CRM) system executing on one or more servers, providing a vendor interface to the CRM system, providing a client interface to the CRM system, wherein the client interface enables clients to send accounts to the CRM system for pre-legal and legal work, monitor performance on the accounts, and review the accounts, providing an attorney interface to the CRM system, wherein the attorney interface provides for receiving the accounts in the legal work flow and reporting on status of the accounts in the legal work flow, and providing a consumer interface to the CRM system, wherein the consumer interface enables a consumer to view and make payments to an account associated with the consumer. The method further includes accepting accounts for legal recovery into the CRM system from one or more clients, applying a pre legal work flow to the accounts for legal recovery in the CRM system, applying a legal decision matrix to determine whether the accounts advance to a legal work flow from the pre legal work flow, and for the accounts which advance to the legal work flow, assigning the accounts to one or more attorneys and communicating information about the accounts through the attorney interface.

According to another aspect, a system for legal processing is provided. The system includes a customer relationship management (CRM) system wherein the customer relationship management system executes on at least one computing device and is cloud-based. The system further includes a vendor interface to the CRM system, the vendor interface available through the cloud for interacting with the CRM system, wherein the vendor interface enables vendors to perform vendor functions. The system further includes a client interface to the CRM system, the client interface available through the cloud for interacting with the CRM system, wherein the client interface enables clients to perform client functions. The system further includes a consumer interface, the consumer interface available through the cloud for interacting with the CRM system, wherein the consumer interface enables consumers to perform consumer functions. The system is configured for accepting accounts for legal recovery into the CRM system from one or more clients, applying a pre legal work flow to the accounts for legal recovery in the CRM system, and applying a legal decision matrix to determine whether the accounts advance to a legal work flow from the pre legal work flow.

### BRIEF DESCRIPTION OF THE DRAWINGS

FIG. 1 is a block diagram illustrating another example of a system.

FIG. 2 provides another example of a process flow overview.

FIG. 3 illustrates another example of a pre-legal work flow.

FIG. 4 illustrates another example of a legal decision matrix.

FIG. 5 illustrates another example of a legal work flow.

FIG. 6 illustrates another example of a case management work flow.

FIG. 7 illustrates an example of a payment module.

FIG. 8 illustrates an example of a compliance module.

FIG. 9 illustrates an example of a non-producing judgment module.

FIG. 10 illustrates an example of a skip trace module.

FIG. 11 is a block diagram illustrating another example of a system of the present invention.

### DETAILED DESCRIPTION OF THE PREFERRED EMBODIMENTS

The present invention provides for managing the debt collection process, including where the legal process is used for debt collection. The present invention allows for a systematic and complete management of various phases in order to provide transparency, increased efficiency, and more control over the process.

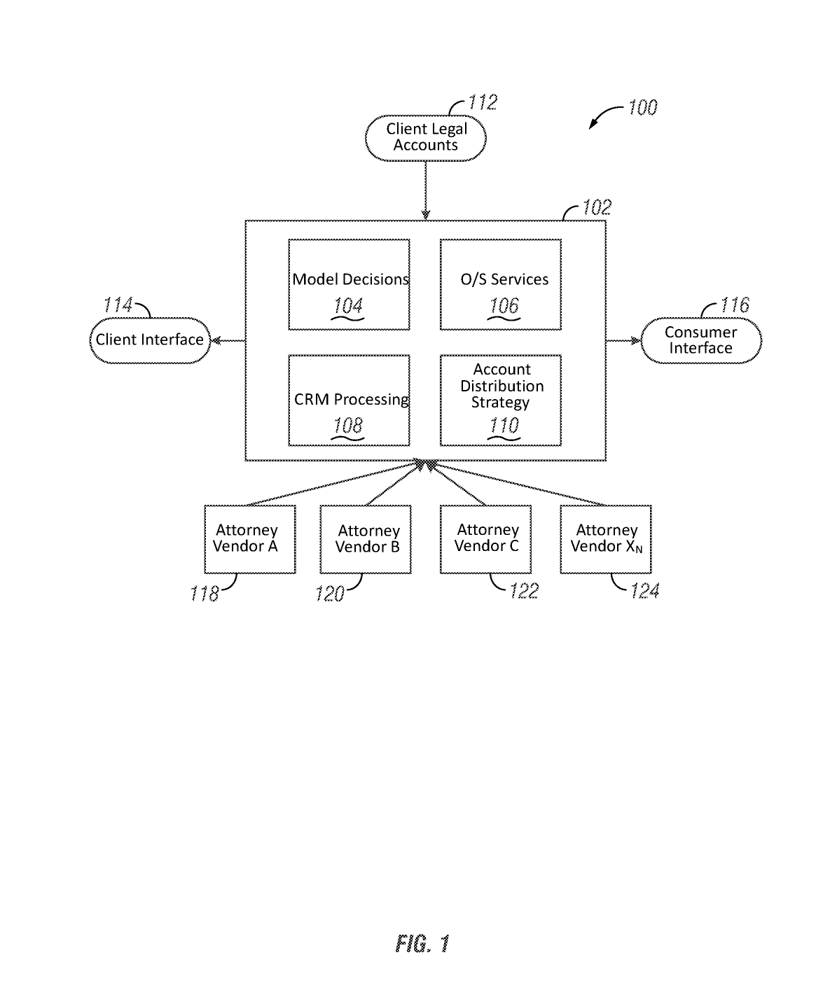

FIG. 1 is a block diagram illustrating another embodiment of a system 100. As shown in FIG. 1, a computing system 102 provides for model decisions 104, 0/S services 106, CRM processing 108, and applying an account distribution strategy 110. The computing system provides for receiving client legal accounts 112 from clients and provides a client interface 114 such as through a cloud-based platform. A consumer interface 116 is also provided. In addition interactions can occur with various vendors including a first attorney 118, a second attorney 120, a third attorney 122, and additional attorneys 124 as shown.

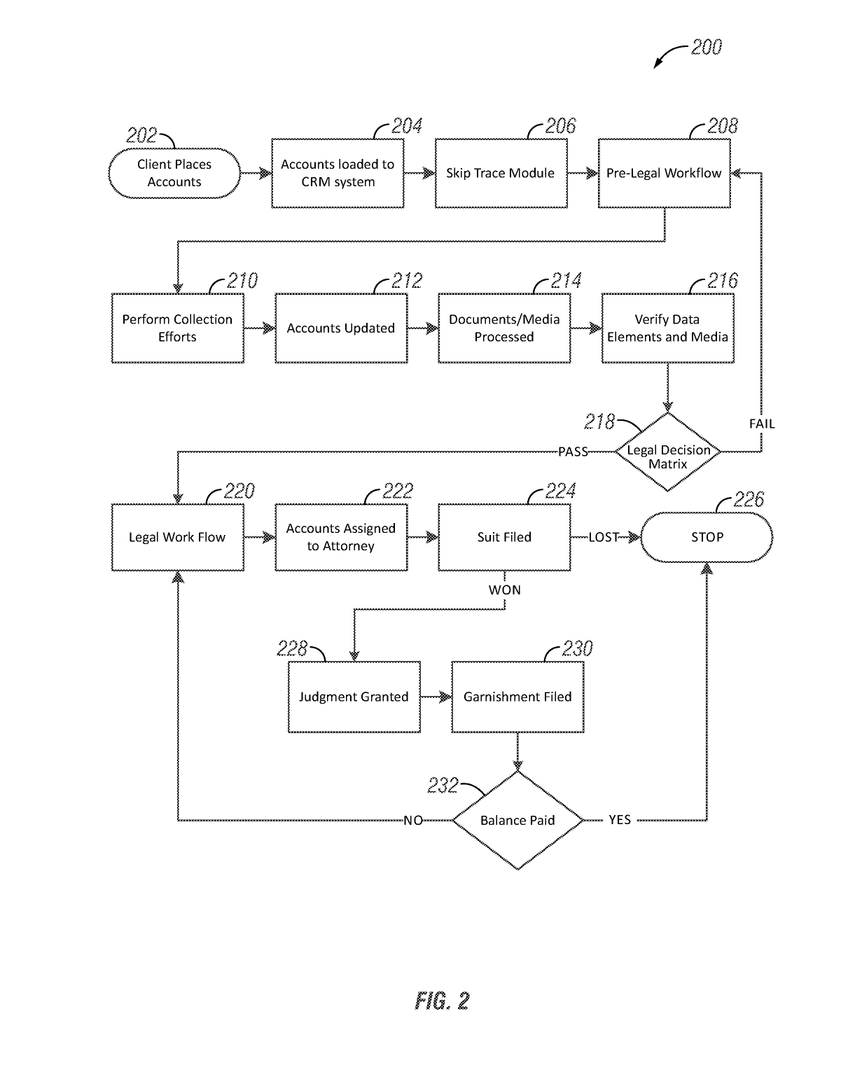

FIG. 2 provides another example of a process flow overview. The process 200 is shown. In a first step 202 a client places accounts and in step 204 the accounts are loaded into the CRM system. In step 206 the skip trace module is executed for the accounts. The skip tracing may use a waterfall process as described in U.S. patent application Ser. No. 14/026,074 (“cloud based skip tracing”), hereby incorporated by reference in its entirety. Skip tracing may be performed using services from one or more vendors. In step 208 the pre-legal workflow process is executed allowing for a pause if a payment posts. In step 210 collection efforts are performed. In step 212 accounts are updated. In step 214 documents and/or media are processed. In step 216 data elements and media are updated. In step 218 a legal decision matrix is implemented. For accounts that fail, these accounts are returned to the pre-legal workflow 208. For accounts which pass, these accounts are advanced to the legal work flow process 220. Then in step 222, the accounts are assigned to an attorney. In step 224 a suit is filed. If the suit is lost then the process stops in step 226. If the suit is won then in step 228 a judgment is granted and in step 230 a garnishment is filed. In step 232 a determination is made as to whether the balance is paid. If it is then the process stops in step 226. If not, then the process continues to the legal work flow 220. Thus, the process 200 provides for managing collection efforts.

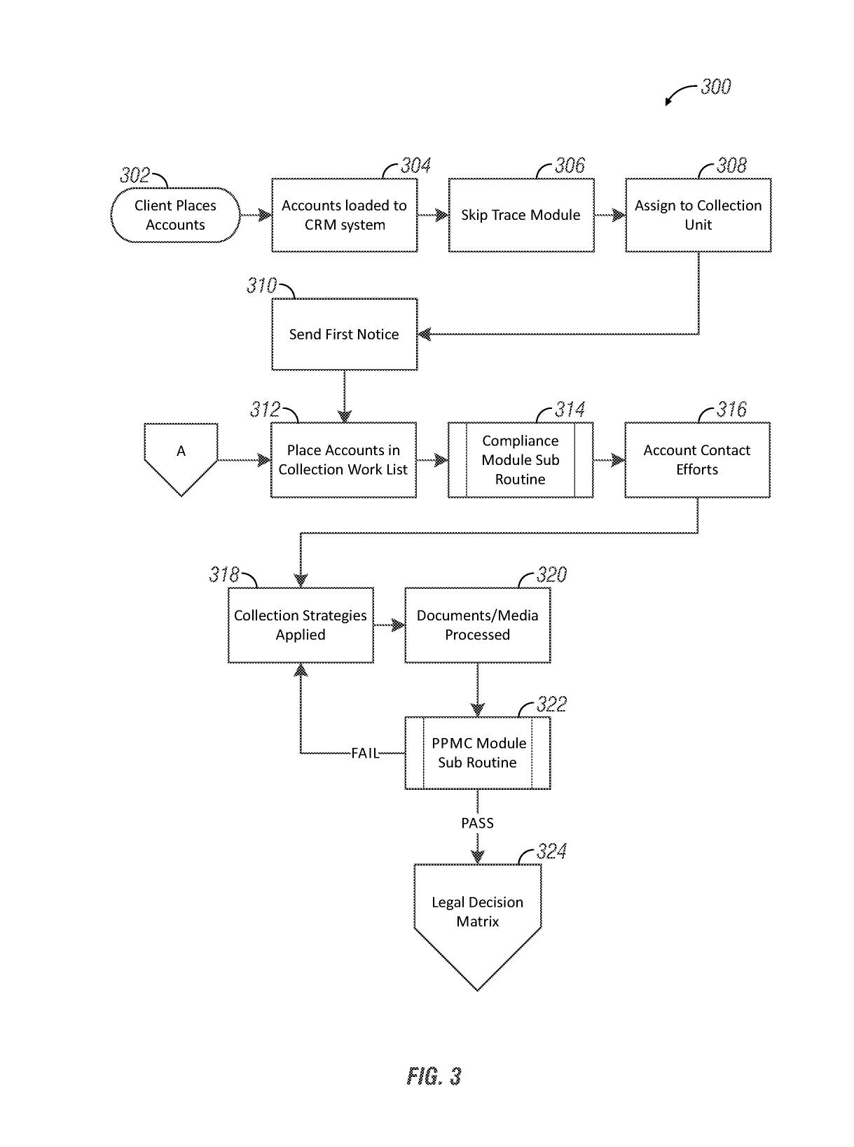

FIG. 3 illustrates another example of a pre-legal work flow. According to the pre-legal workflow 300, in step 302 a client places accounts. In step 304, the accounts are loaded into a CRM system. In step 306 a skip trace module is applied. In step 308 each account is assigned to a collection unit. In step 310 a first notice is sent. In step 312 the accounts may be placed in a collection work list. In step 314 a compliance module subroutine may be executed to ensure compliance. In step 316 account contact efforts may be performed. In step 318 collection strategies may be applied. The collection strategies may include sending the accounts to a dialer and having representatives speak with the debtor. In step 320, documents and/or media related to the debt may be processed. In step 322 a payment module sub-routine may be executed. If the module fails, the process returns to step 318. If the module passes, then in step 324 the account or accounts can proceed to the legal decision matrix.

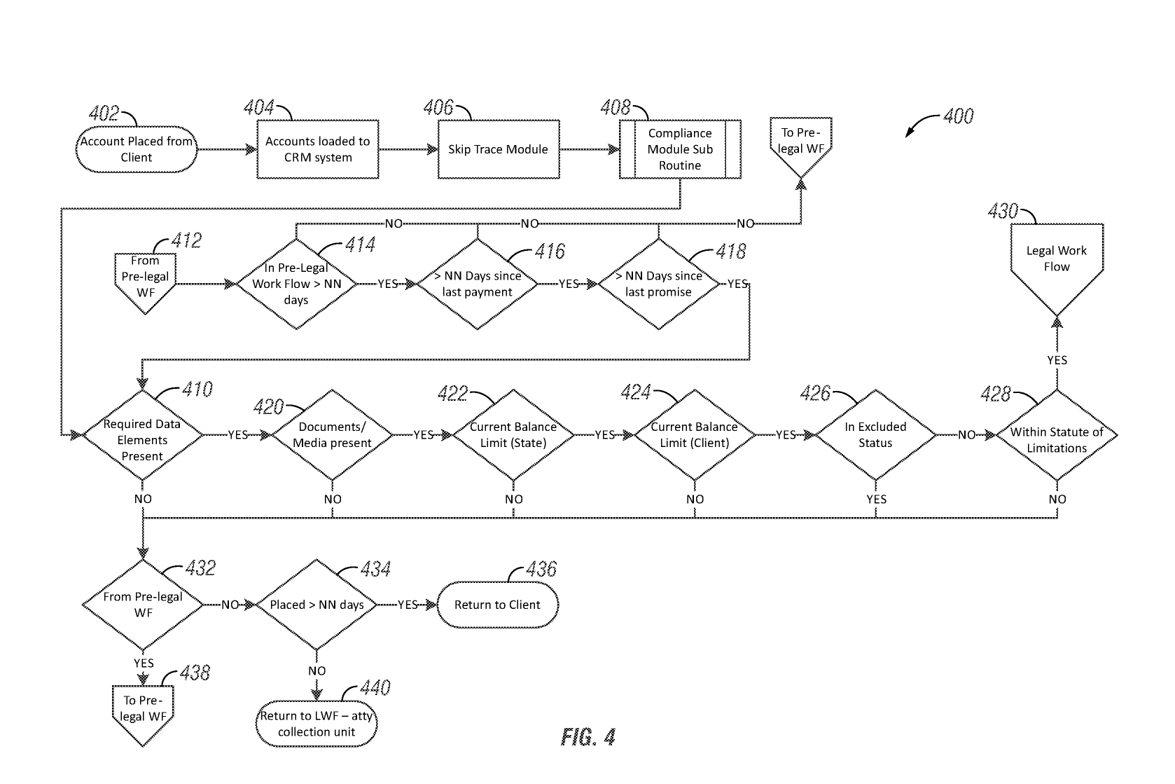

FIG. 4 illustrates another example of a legal decision matrix 400. In step 402 accounts are placed from a client. In step 404 accounts are loaded into the CRM system. In step 406 a skip trace module is executed. In step 408 a compliance module sub-routine is executed. In step 410 a determination is made as to whether required data elements are present. If they are then in step 420 a determination is made as to whether documents and/or media needed to support a legal claim are present. If they are then in step 422 a determination is made as to whether a current balance limit has been reached as may be set by a particular state level requirements. If it is then in step 424 a determination is made as to whether a current balance limit is reached as set by the client. If it is then in step 426 a determination is made as to whether the account is in an excluded state. If it is not, then in step 428 a determination is made as to whether the debt owed falls within the statute of limitations. If it does, then the account is then moved to the legal work flow process 430. If in step 410 required data elements are not present, or in step 420 documents and media is not present, or if in step 422 the current balance limit is not reached for the state, or if in step 424 the current balance limit is not reached for the client, of if in step 426 the account is in an excluded state, or in step 428 the debt owed is not within the statute of limitations then the process proceeds to step 432 where a determination is made as to whether the account was from a pre-legal workflow. If it was not, then in step 434 a determination is made as to how long the account has been placed. If the account has been placed for greater than a threshold number of days then in step 436 the account is returned to the client. If in step 434 the account has not been placed for greater than a threshold number of days, in step 440 the account may be returned to legal work flow. If in step 432 a determination is made that the account came from a pre-legal workflow then in step 438 the account may be returned to the pre-legal workflow.

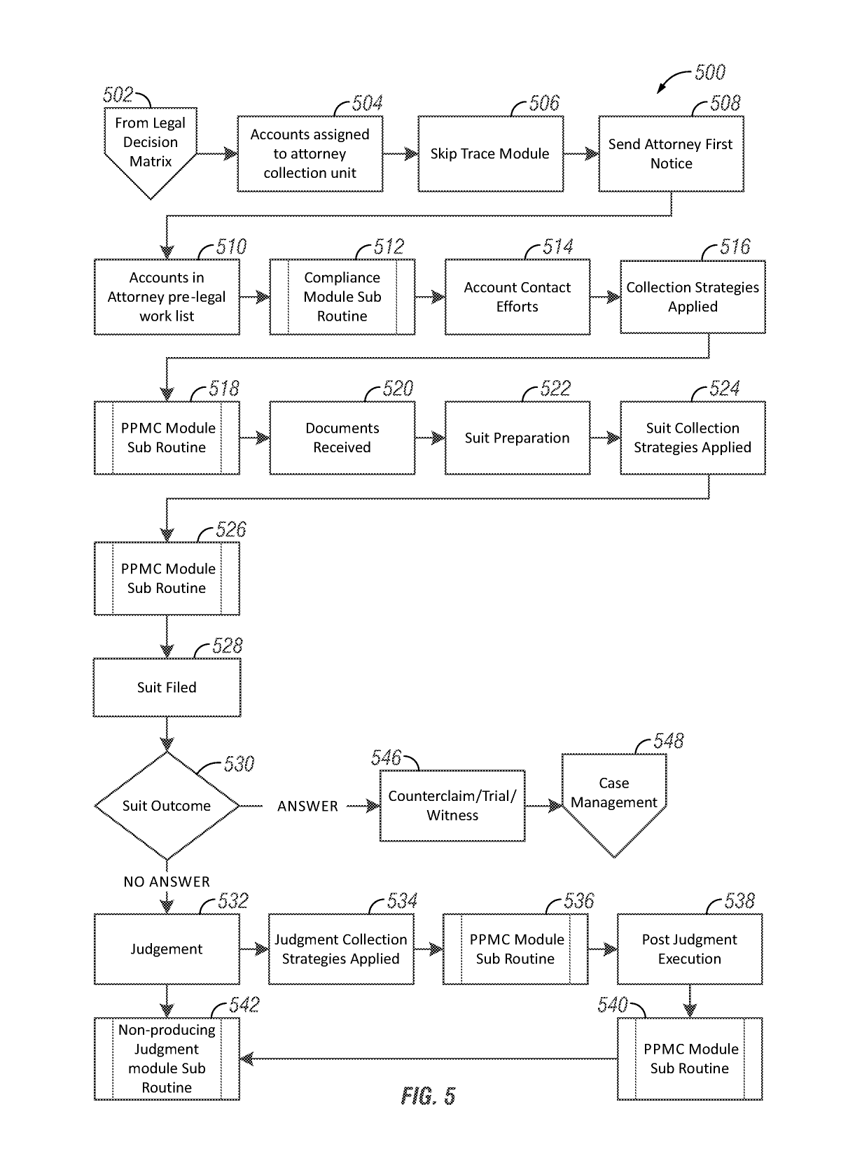

FIG. 5 illustrates another example of a legal work flow. In the process 500, in step 502 one or more accounts are received from the legal decision matrix. In step 504 the accounts are assigned to an attorney collection unit. In step 506 a skip trace module may be executed. In step 508 a first notice may be sent. In step 510 accounts are placed in an attorney pre-legal work list. In step 512 a compliance module sub routine may be executed. In step 514 account contact efforts are implemented. In step 516 collection strategies are applied. In step 518 a payment, promise, mail return, compliance (PPMC) module subroutine is executed. The PPMC module is used to track payments, promises to make payments, mail returns, and compliance including compliance with promise to make payments. In step 520 documents are received. In step 522 a law suit is prepared. In step 524 suit collection strategies are applied. In step 526 a PPMC module sub-routine is executed. In step 528 a suit is filed. In step 530 a determination is made as to whether or not there was an answer. If not, then the process proceeds to a judgment in step 532. If there is an answer then in step 546 the answer can be evaluated to determine if there are counterclaims, if there will be a trial, if witnesses are need and in step 540 the process proceeds for case management. Returning to step 532 after there is a judgment, in step 534 judgment collection strategies may be applied. In step 536 a PPMC module sub-routine may be executed. In step 538 post judgment execution is performed. In step 540 a PPMC module sub routine may be executed. In step 542 a non-producing judgment module sub routine may be executed.

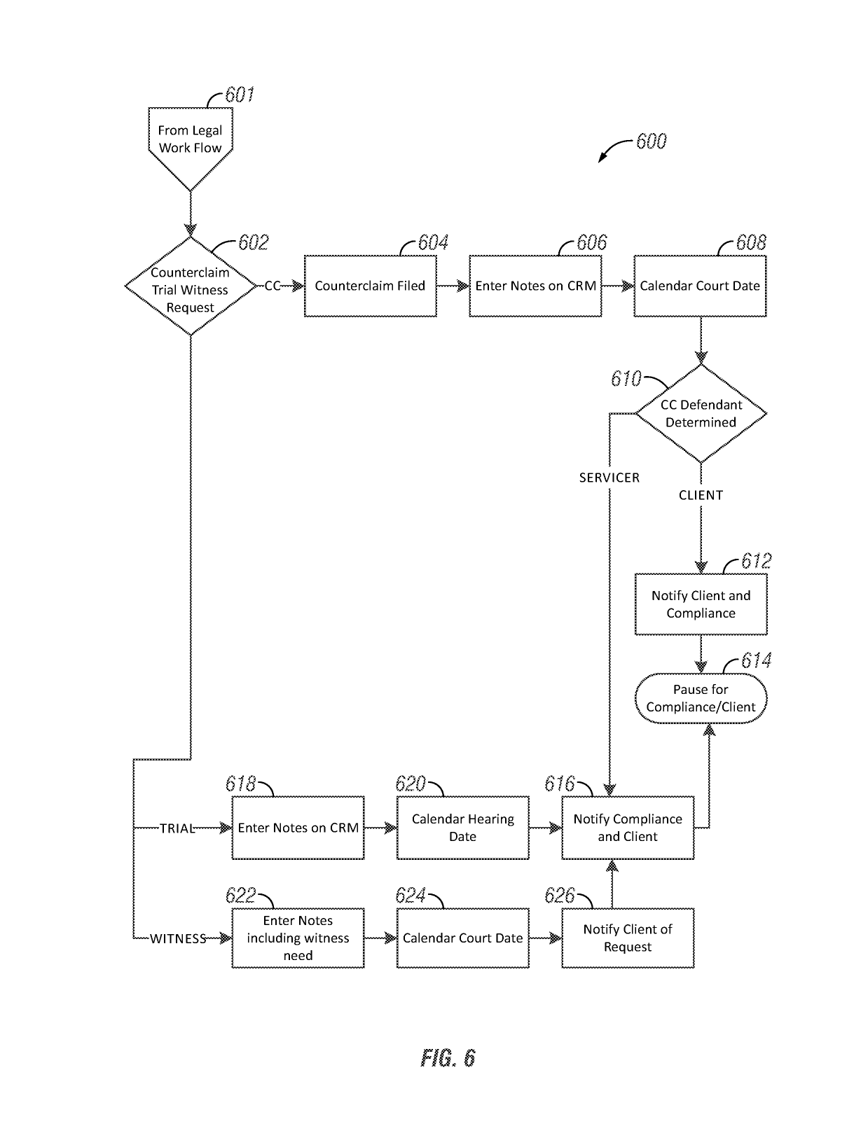

FIG. 6 illustrates another example of a case management work flow. The process 600 begins in step 601 from the legal work flow. In step 602 a determination is made as to whether counter claims were filed, a trial is needed, or there is a request for a witness. If there is a counterclaim then in step 604 a counterclaim has been filed and so in step 606 appropriate notes are entered in the CRM system. In step 608 the appropriate court date is calendared. In step 610 the counterclaim defendant is determined. If the counterclaim defendant is the client then in step 612 the client is notified and a compliance department is notified. In step 614 the process may be paused to allow time for compliance and the client to become involved. Returning to step 610 if a determination is made that the counterclaim defendant is the servicer, then in step 616 the compliance department and compliance may be notified. Returning to step 602 if the case is to proceed to trial, in step 618 notes may be entered on the CRM system and in step 620 a hearing date may be calendared. Returning to step 602 if there are witnesses, then in step 622 notes including the witnesses needed may be entered on the CRM system. Then in step 624 the court date may be calendared and in step 626 the client is notified of the request for a witness.

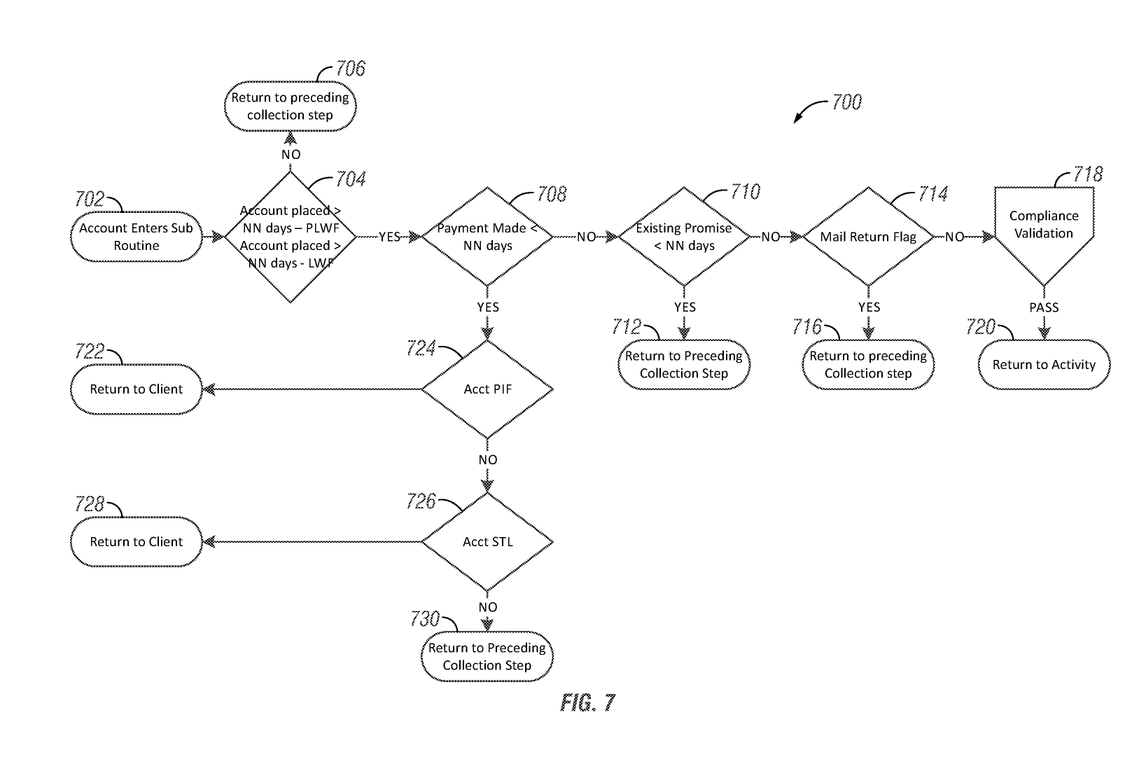

FIG. 7 illustrates an example of operation of a payment module 700. In step 702 an account enters the sub routine. In step 704 a determination is made as to how long the account has been placed. This determination may take into account the length of time the account has been placed in pre-legal workflow or the length of time the account has been placed in legal workflow. For example, if the account has been place for greater than a threshold number of days in pre-legal workflow (or legal work flow), the process proceeds to step 708. If the account has not been placed for a sufficient amount of time, then the process proceeds to step 706 back to the appropriate collection step. If in step 704 a determination is made that the account has been placed for the appropriate number of days, then in step 708 a determination is made as to whether a payment has made within a threshold number of days. If it has, then in step 724 a determination is made as to whether the payment was payment in full. If it was then the account is returned to the client in step 722. If there is a payment, but it is not payment in full, then in step 726 a determination is made as to whether the account has been settled. If it has, then in step 728 the account returns to the client. If not, then in step 730 the process returns to the preceding collection step. Returning to step 708, if no payment is made within the given time period, then in step 710 a determination is made as to whether there is an existing promise to pay within the given time period. If there is, then in step 712 the process returns to a preceding collection step. If not, then in step 714 a determination is made as to whether there is a mail return flag indicating that mail has been returned. If there is, then in step 716 the process returns to the preceding collection step. If not, then in step 718 compliance validation occurs and if passed, in step 720 the process returns.

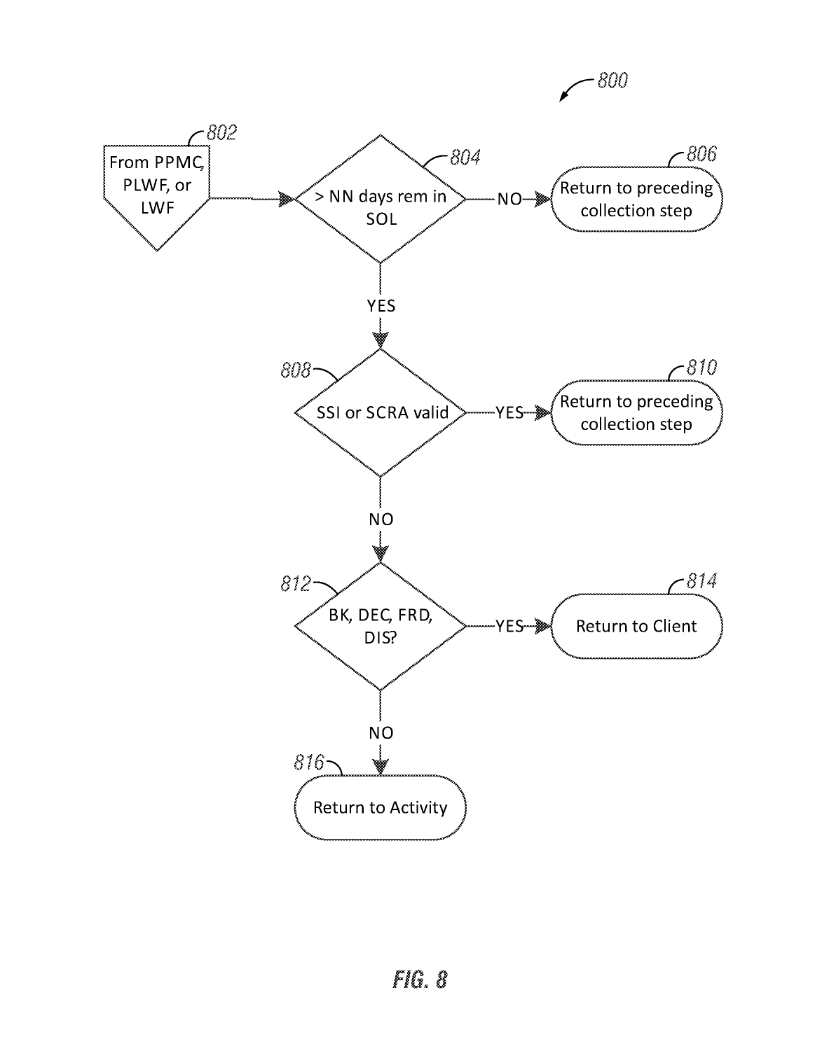

FIG. 8 illustrates an example of a compliance module 800. In step 802, the process is invoked from a PPMC, pre-legal workflow, or legal workflow. In step 804 a determination is made as to whether the number of days remaining in the statute of limitations (SOL) is greater than a threshold number of days. If it is not, then in step 806 the process returns to the preceding collection step. If it is, then in step 808 a determination is made as to whether the Social Security Income (SSI) or the Servicemembers Civil Relief Act (SCRA) classification is valid. If it is, then in step 810 the process returns to the preceding collection step. If it is not, then in step 812 a determination is made as to whether there is a bankruptcy or whether the debt involves a deceased individual, fraud is alleged, or there is a dispute as to amount. If it is then in step 814 the account is returned to the client. If not, then in step 816 the process returns to normal activity.

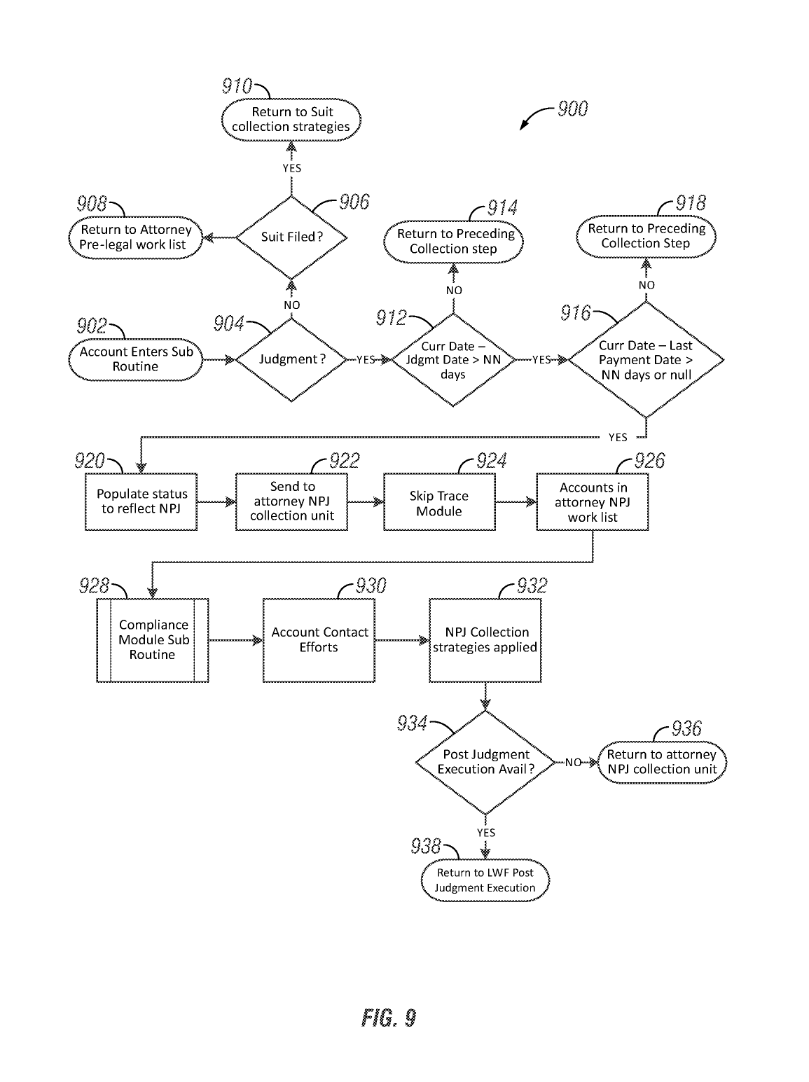

FIG. 9 illustrates an example of a non-producing judgment module 900. In step 902 an account enters the sub routine. In step 904 a determination is made as to whether there is a judgment. If not, then in step 906 a determination is made as to whether a suit has been filed. If not, then in step 908 the account returns to the attorney pre-legal work list. If there is a suit filed then in step 910 the process returns to suit collection strategies. Returning to step 904 if there is a judgment then in step 912 a determination is made as to whether the difference between the current date and the judgment date is greater than a threshold. If not, then in step 914 the process returns to the preceding collection step. If it is, then in step 916 a determination is made as to whether the difference between the current date and the last payment date is greater than a threshold or null. If not, then in step 918 the process returns to the preceding collection step. If it is, then in step 920 the status in the CRM system is populated to reflect a non-producing judgment. Then in step 922, the account is sent to an attorney non-producing judgment unit. In step 924 a skip trace module is executed. In step 926 accounts are placed in the attorney non-producing judgment work list. In step 928 the compliance module sub routine is executed. In step 930 account contact efforts are performed. In step 932 non-producing judgment strategies are applied. In step 934 a determination is made as to whether post judgment execution is available. If not, then in step 936 the account is returned to the attorney non-producing judgment collection unit. If execution is available, then in step 938 the process returns to the legal work flow post judgment execution.

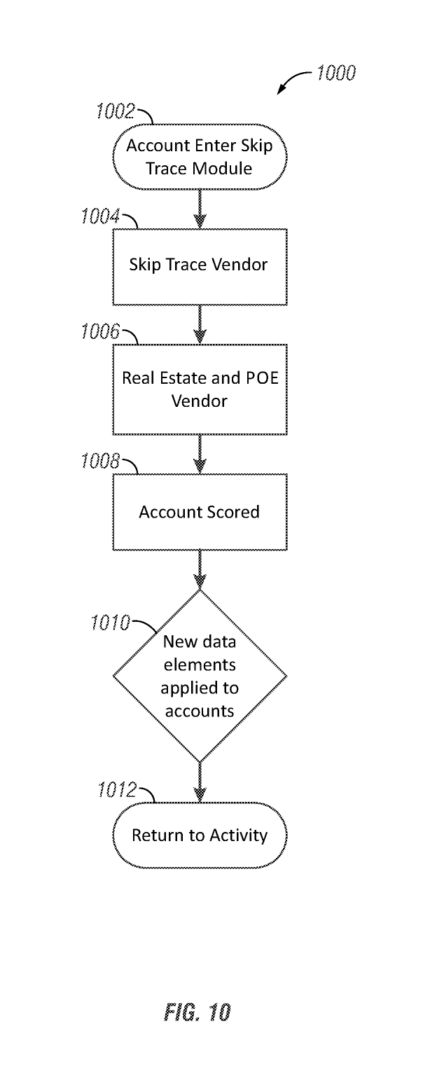

FIG. 10 illustrates an example of a skip trace module 1000. In step 1002 an account enters the skip trace module. In step 1004 one or more skip trace vendors are used to find a consumer owing debt. In step 1006 a real estate and place of employment (POE) vendor is used. In step 1008 the account is scored. In step 1010 a determination is made as to whether new data elements are applied to the accounts. In step 1012 the skip trace module is completed and the process returns to its previous activity.

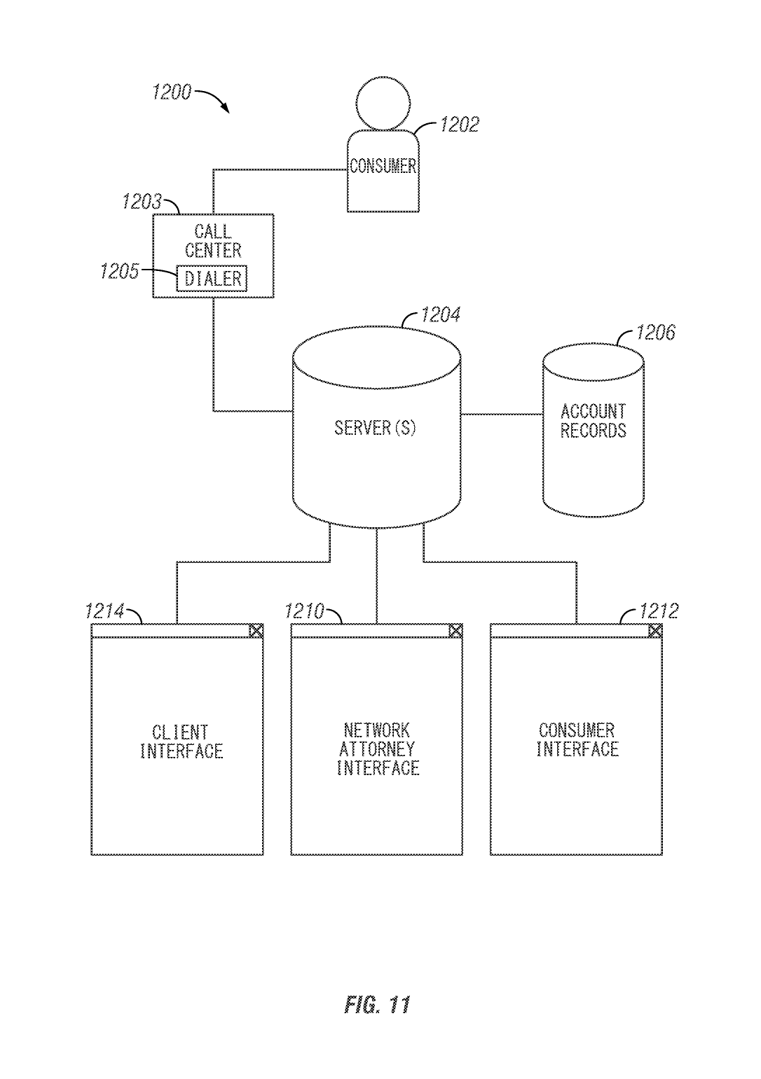

FIG. 11 is a block diagram illustrating a system 1200. As shown in the system 1200 there is a consumer 1202. The consumer can interact with a call center 1203 which may include a dialer 1205. The call center 1203 may be operatively connected to one or more servers 1204. Thus, one or more dialers may be integrated with a CRM system. The dialer(s) may be used for placing calls or routing inbound calls. Account records 1206 may be stored in a database operatively connected to the server(s) 1204 associated with a CRM system. Various different user interfaces are also provided. These include a network attorney interface 1210 which is an example of a vendor interface, a consumer interface 1212, and a client interface 1214.

The invention allows for a comprehensive system and methodology which allows for one entity such as a debt collection agency to manage the debt collection process in an efficient and effective manner. Because a single system and integrated methodology is used, the status of a given account can be readily determined at any point in time. This is a significant advantage, especially with respect to those accounts which have been referred out to attorneys for collections. In addition, because an integrated system is used workflows can be controlled to ensure efficiency and transparency throughout the process.

As previously explained, the system may be a cloud-based server which executes on a server. The server may be a virtual server or physical server and may be distributed across multiple machines to provide services such as those described herein. The server may be programmed in software to perform the functions described, with instruction sets executing on the server performing the functionality described. The instructions as well as data may be stored on non-transitory computer readable storage media.

Therefore, various embodiments have been showing related to systems, methods, and apparatus associated with debt collection. Although specific examples are shown, the present invention should not be limited to these specific examples as various options and alternatives are contemplated such as may be appropriate in particular circumstances.

What is claimed is:

1. A method for managing legal recoveries, the method comprising:
providing a customer relationship management (CRM) system executing on one or more servers;
providing a client interface to the CRM system, wherein the client interface enables clients to send accounts to the CRM system for pre-legal and/or legal work, monitor performance on the accounts, and review the accounts;
providing an attorney interface to the CRM system, wherein the attorney interface provides for receiving the accounts in the legal work flow and reporting on status of the accounts in the legal work flow;
providing a consumer interface to the CRM system, wherein the consumer interface enables a consumer to view and make payments to an account associated with the consumer;
accepting accounts for legal recovery into the CRM system from one or more clients;
applying a pre legal work flow to the accounts for legal recovery in the CRM system;
applying a legal decision matrix by the CRM system to determine whether the accounts advance to a legal work flow from the pre legal work flow;
for the accounts which advance to the legal work flow, assigning the accounts to one or more attorneys and communicating information about the accounts through the attorney interface.

2. The method of claim 1 wherein the CRM system is integrated with a dialer.

3. The method of claim 2 wherein the dialer provides for call routing of inbound calls.

4. The method of claim 1 further comprising a vendor interface in addition to the attorney interface wherein the vendor interface comprises at least one of a vendor interface for receiving credit reporting, a vendor interface for skip tracing, a vendor interface for automated payment processing, and a vendor interface for consumer communications.

5. The method of claim 1 wherein the accepting the accounts for legal recovery into the CRM system from one or more clients is performed through the client interface.

6. The method of claim 1 wherein the CRM system includes a module for managing kept promises from the consumers and broken promises from the consumer regarding payment.

7. The method of claim 1 wherein the module further provides for managing payments made without promises and payment reversals.

8. The method of claim 1 wherein the pre legal work flow comprises collecting documents associated with the accounts based on state requirements and client requirements and storing the documents in the CRM system.

9. A system for legal processing, comprising:
a customer relationship management (CRM) system wherein the customer relationship management system executes on at least one computing device and is cloud-based;
a vendor interface to the CRM system, the vendor interface available through the cloud for interacting with the CRM system, wherein the vendor interface enables vendors to perform vendor functions;
a client interface to the CRM system, the client interface available through the cloud for interacting with the CRM system, wherein the client interface enables clients to perform client functions; and
a consumer interface, the consumer interface available through the cloud for interacting with the CRM system, wherein the consumer interface enables consumers to perform consumer functions;
wherein the system is configured for accepting accounts for legal recovery into the CRM system from one or more clients, applying a pre legal work flow to the accounts for legal recovery in the CRM system, and applying a legal decision matrix to determine whether the accounts advance to a legal work flow from the pre legal work flow.

10. The system of claim 9 further comprising a module for managing kept promises from the consumers and broken promises from the consumer.

11. The system of claim 10 wherein the module further provides for managing payments without promises and payment reversals.

12. The system of claim 9 further comprising a dialer, the dialer integrated with the CRM system.

13. The system of claim 9 wherein the vendor interface is configured for use by attorneys and wherein the vendor interface enables attorneys to perform attorney functions associated with the system.
